(19) United States
(12) Patent Application Publication
(10) Pub. No.: US 2004/0190171 A1
(43) Pub. Date: Sep. 30, 2004

(54) Content recording apparatus

(76) Inventor: Eiji Nakai, Osaka (JP)

Correspondence Address: Gerald T. Bodner, Esq., BODNER & O'ROURKE, LLP, Suite 108, 425 Broadhollow Road, Melville, NY, 11747, US

(21) Appl. No.: 10/806,606

(22) Filed: Mar. 23, 2004

(30) Foreign Application Priority Data
Mar. 24, 2003 (JP) 2003-81516

(51) Int. Cl. G11B 5/09

(52) U.S. Cl. 360/39

(57) ABSTRACT

A content recording apparatus applied to a hard disk video recorder includes a hard disk. If a power is instantly cut off when content data is being normally recorded into an MPEG file formed in the hard disk, the normal recording is suspended, without recording into an index file index data corresponding to the content data. When a supply of the power is resumed, a temporal discontinued point of the index data is searched based on time information included in the index data, and a vicinity of a location on the MPEG file corresponding to the detected discontinued point is set as a recording starting location. The normal recording of the content data is started from the set recording starting location.

### BACKGROUND OF THE INVENTION

1. Field of the invention

The present invention relates to a content recording apparatus. More specifically, the present invention relates to a content recording apparatus adapted to a surveillance camera system, and recording content data into a recording medium.

2. Description of the prior art

In such a kind of a conventional content recording apparatus, content data is linearly recorded into a recording medium, and is overwritten from a head address when the recording medium becomes full. However, in a linear recording, in a case that a recording operation is abnormally ended due an instant cutting-off of a power such as a power failure, it is not easy to search a recording ending location. This, in the prior art, makes it impossible to resume the recording operation from a vicinity of the recording ending location.

### SUMMARY OF THE INVENTION

Therefore, it is a primary object of the present invention to provide a content recording apparatus capable of resuming a recording operation from a vicinity of a recording ending location even when an abnormal ending of the recording operation occurs.

A content recording apparatus according to the present invention comprises: a designator for designating in the order from a reference data file a plurality of data files; a data writer for writing content data into the data file designated by the designator; an information writer for writing into a non-volatile storing area file information that identifies the data file designated by the designator at each time that a designation of the designator is updated, wherein the reference data file is a data file specified by the latest file information stored in the non-volatile storing area.

The designator designates in the order from a reference data file a plurality of data files. The content data is written by the data writer into the data file designated by the designator. The information writer writes into a non-volatile storing area file information that identifies the data file designated by the designator at each time that a designation of the designator is updated. Herein, the reference data file is a data file specified by the latest file information stored in the non-volatile storing area.

The file information that identifies the designated data file is written into the non-volatile storing area at each time that the designation is updated so that it is possible to easily recognize into which of the data files the writing operation is suspended during a time that the writing is being done. This enables to resume the recording operation from the vicinity of the recording ending location even when an abnormal ending of the writing operation occurs.

Preferably, a marker is written by a marker writer into the non-volatile storing area at a time of ending a writing operation by the data writer. Whether or not the marker exists in the non-volatile storing area is determined by a determiner before starting the writing operation by the data writer. A detector detects a data discontinued point from the reference data file when a determination result of the determiner is negative, and a determiner determines a writing starting location on the reference data file based on the detected data discontinued point. This enables to resume the recording operation by an error below a size of the data file.

Further preferably, the content data includes moving image data having a plurality of frames of an image, and index data that manages each of the plurality of frames, and each of the plurality of data files includes a moving image file that stores the moving image data, and an index file that stores the index data.

In a case that the index data includes time information indicating a time at which each of the plurality of frames of an image has been obtained, and the detector preferably detects the data discontinued point based on the time information.

In a case that the plurality of frames of an image include a first encoded image to which an intra-encoding is applied, and a second encoded image to which an inter-encoding is applied, the determiner preferably determines as the writing starting location a location that precedes the data discontinued point and in which the first encoded image exists.

In a case that the content data is temporarily stored in a buffer prior to a writing operation by the data writer, the determiner determines the writing starting location taking into consideration a capacity of the buffer.

Preferably, the plurality of data files have the same capacity to each other. This a maximum value of an error between the writing ending location and the writing starting location even between the data files.

A content recording method according to the present invention comprises: a recorder for recording into a recording medium content data formed of a plurality of partial contents; a creator for creating index data including location information indicating a location of each of the plurality of partial contents, and time information indicating a time at which each of the plurality of partial contents has been obtained; a detector for detecting a temporal discontinuing point of the index data based on the time information before a recording operation by the recorder is started; and a first determiner for determining a location of starting recording the content data based on the temporal discontinuing point detected by the detector.

The content data is formed of the plurality of partial contents. The recorder records into a recording medium such the content data, and the creator creates index data including location information indicating a location of each of the plurality of partial contents, and time information indicating a time at which each of the plurality of partial contents has been obtained.

The detector detects a temporal discontinuing point of the index data based on the time information before a recording operation by the recorder is started; and a first determiner determines a location of starting recording the content data based on the temporal discontinuing point detected by the detector.

This enables to resume the recording operation from a vicinity of the recording ending location even when an abnormal ending of the recording operation occurs.

Preferably, a marker is written into a non-volatile storing area by a marker writer at a time of ending a recording operation by the recorder. A determiner determines whether or not the marker exists in the non-volatile storing area when a power is input. The detector detects the temporal discontinuing point when a determination result of the determiner is negative.

Further preferably, location information indicating an ending location of the recording operation is written by an information writer into the non-volatile storing area. A second determiner determines a location for starting recording the content data based on the location information written in the non-volatile storing area when the determination result of the determiner is affirmative.

Preferably, the content data is moving image data having a plurality of frames of an image, and each of the plurality of partial contents includes one of a first encoded image to which an intra-encoding is applied, and a second encoded image to which an inter-encoding is applied. At this time, the first determiner determines as a recording starting location a head of the partial content including the first encoded image recorded in the recording medium.

Preferably, a plurality of data files are formed in the recording medium, and the recorder sequentially records the content data into the plurality of data files.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing one embodiment of the present invention;

FIG. 2 is an illustrative view showing one example of data structure of index data and an MPEG-PS;

FIG. 3 is an illustrative view showing one example of a managing file created by a FIG. 1 embodiment;

FIG. 4 is an illustrative view showing one example of a recording information file created by the FIG. 1 embodiment;

FIG. 5(A) is an illustrative view showing one example of a writing state of a managing file;

FIG. 5(B) is an illustrative view showing another example of the writing state of the managing file;

FIG. 5(C) is an illustrative view showing the other example of the writing state of the managing file;

FIG. 5(D) is an illustrative view showing a further example of the writing state of the managing file;

FIG. 6 is an illustrative view showing one portion of an operation of the FIG. 1 embodiment;

FIG. 7 is a flowchart showing one portion of the operation of the FIG. 1 embodiment;

FIG. 8 is a flowchart showing another portion of the operation of the FIG. 1 embodiment;

FIG. 9 is a flowchart showing the other portion of the operation of the FIG. 1 embodiment;

FIG. 10 is a flowchart showing a further portion of the operation of the FIG. 1 embodiment;

FIG. 11 is a flowchart showing another portion of the operation of the FIG. 1 embodiment;

FIG. 12 is a flowchart showing the other portion of the operation of the FIG. 1 embodiment; and

FIG. 13 is a flowchart showing a further portion of the operation of the FIG. 1 embodiment.

### DETAILED DESCRIPTION OF THE PREFERRED EMBODIMENTS

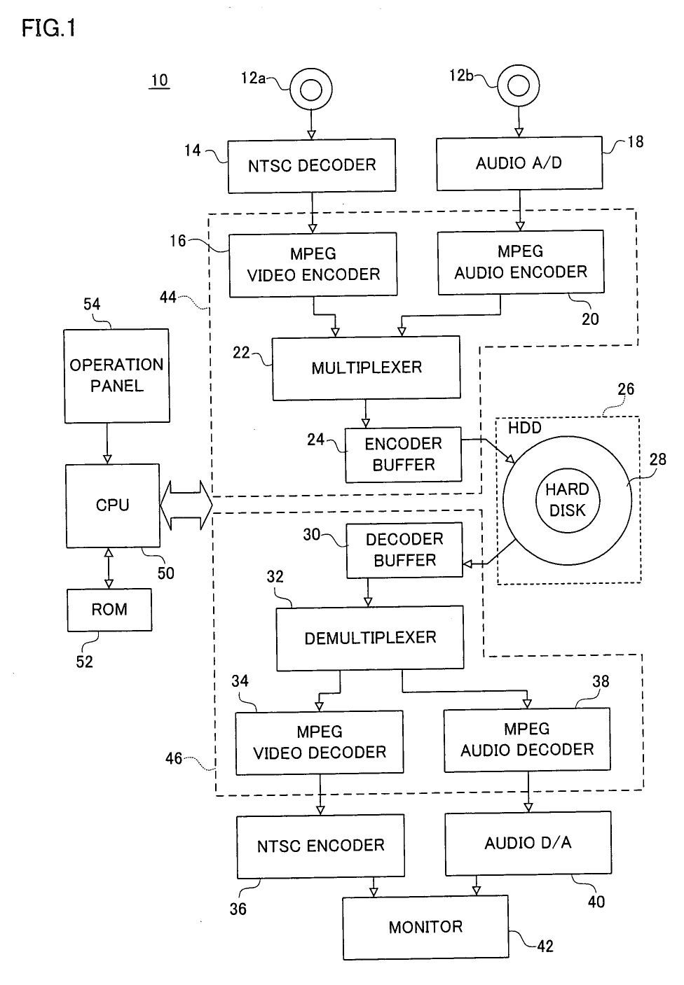

Referring to FIG. 1, a hard disk video recorder 10 of this embodiment includes a video input terminal 12a and a sound input terminal 12b. A composite video signal output from a surveillance camera (not shown) is input into the video input terminal 12a, and an audio signal output from the same surveillance camera is input into the sound input terminal 12b. The composite video signal is applied to an NTSC decoder 14, and the audio signal is applied to an audio A/D converter 18.

The NTSC decoder 14 decodes the applied composite video signal, and outputs video data. On the other hand, the audio A/D converter 18 applies an AID conversion to the audio signal so as to output audio data.

The video data and the audio data are applied to an MPEG video encoder 16 and an MPEG audio encoder 20, respectively, that form an MPEG encoder 44. The video data is converted into a video PES by the MPEG video encoder 16, and the audio data is converted into an audio PES by the MPEG audio encoder 20.

A multiplexer 22 multiplexes the video PES and the audio PES output from the MPEG video encoder 16 and the MPEG audio encoder 20 so as to create an MPEG-PS. In addition, the multiplexer 22 creates INDEX data that manages a video frame forming the MPEG-PS. The created MPEG-PS and INDEX data are applied to an HDD (Hard Disk Drive) 26 via an encoder buffer 24. It is noted that the encoder buffer 24 has a capacity capable of storing approximately 30 seconds of the MPEG-PS and the INDEX data.

The HDD 26 has an incorporated hard disk 28. The HDD 26 writes the applied MPEG-PS and INDEX data into an MPEG file and an INDEX file that are formed in the hard disk 28, respectively. A video and a sound or voices perceived by the surveillance camera is thus recorded into the hard disk 28.

When the MPEG-PS stored in the MPEG file is reproduced by the HDD 26, the reproduced MPEG-PS is applied to a demultiplexer 32 via the decoder buffer 30 that forms the MPEG decoder 46. The decoder buffer 30, too, has a capacity capable of storing the approximately 30 seconds of the MPEG-PS. The demulplexer 32 extracts the video PES and the audio PES from the applied MPEG-PS, and applies the extracted video PES and audio PES to the MPEG video decoder 34 and the MPEG audio decoder 38, respectively.

The MPEG video encoder 34 decodes the applied video PES so as to create the video data, and applies the created video data to the NTSC encoder 36. The NTSC encoder 36 converts the video data into the composite video signal, and outputs the converted composite video signal to a monitor 42. As a result, the video perceived by the surveillance camera is displayed on a screen.

The MPEG audio decoder 38 decodes the applied audio PES so as to create the audio data. The created audio data is converted into an analog audio signal by an audio D/A converter 40, and the converted audio signal is output to the monitor 42. As a result, the sound or voices perceived by the video camera is output from a speaker (not shown).

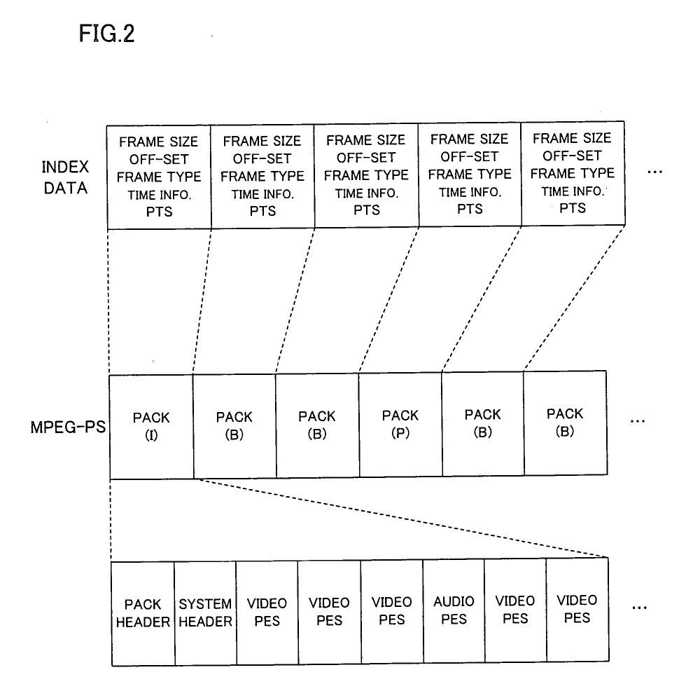

Both the MPEG-PS and the INDEX data stored in the MPEG file and the INDEX file have data structure as shown in FIG. 2. According to FIG. 2, the MPEG-PS is formed of a plurality of packs, and each pack includes a pack header, a system header, a video PES packet, and an audio PES packet.

In an MPEG format, three types are defined, that is, an I picture, a B picture, and a P picture, and the video PES packet that forms one picture is not to stretch over to a different pack. That is, a plurality of the video PES packets that form the I picture in a certain screen are included in the same pack, a plurality of the video PES packets that form the B picture in a certain screen are included in the same pack, and a plurality of the video PES packets that form the P picture in a certain screen are included in the same pack.

The I picture is created by each 30 frames, for example, and one GOP (Group of Pictures) is formed of 30 frames that start from the I picture. The composite video signal output from the surveillance camera has a frame rate of 60 fps, and 30 frames that form one GOP corresponds to 0.5 seconds.

It is noted that the audio PES packet is intermittently inserted between the video PES packets so as to be synchronized between a reproduced video and a reproduced sound or voices to each other. In addition, the I picture is an image to which an intra-encoding is applied, and each of the B picture and the P picture is an image to which an inter-encoding is applied.

The INDEX data is segmented by each 24 bytes, and the segmented 24 bytes are allotted to each picture. The 24 bytes are formed of a frame size indicating a size of a corresponding picture, an MPEG off-set indicating an off-set from a head of the corresponding MPEG file, a frame type indicating a type of the corresponding picture, a time information indicating a time at which the corresponding picture is created, and a PTS (Presentation Time Stamp) indicating a time period elapsed from a start of a recording into the corresponding MPEG file.

It is noted that 4 bytes are allotted to the frame size, 8 bytes are allotted to the MPEG off-set, and 4 bytes are allotted to the frame type. In addition, 4 bytes are allotted to the time information, 4 bytes are allotted to the PTS. By referring to such the INDEX file, it is possible to specify a desired frame from the MPEG file.

In the hard disk video recorder 10 of this embodiment, even while a normal recording operation is not performed by an operator, the recording is performed. Such the recording operation is defined as a “temporary recording”. At this time, the MPEG-PS is circularly written into a temporary recording-use MPEG file having a predetermined size. That is, a recording mode is switched between a normal recording mode and a temporary recording mode depending on presence or absence of the normal recording operation by the operator. In other words, although there is a difference between the normal recording mode and the temporary recording mode, as long as the power is being input, the recording operation is always performed.

Furthermore, in the hard disk video recorder 10 of this embodiment, when a designated-portion reproducing operation is not performed by the operator, the MPEG-PS recorded in the hard disk 28 is instantly reproduced. That is, a recording/reproducing of the same MPEG-PS is approximately simultaneously performed. Such the reproducing operation is defined as a “live reproduction”.

When the designated-portion reproducing operation is performed, the live reproduction is suspended, and the MPEG-PS in the designated portion is reproduced from the hard disk 28. It is noted that during a time that the designated-portion reproducing operation is performed, too, the above-described temporary recording or the normal recording is always executed.

In this embodiment, even if there occurs a trouble that the power is instantly cut-off during the normal recording, in order to resume the normal recording from a recording suspending location at a time of recovering the power, following measures are prepared.

Firstly, a plurality of the MPEG files each of which has 1 G byte is formed in advance in the hard disk 28 for the normal recording. In the hard disk 28, a plurality of the INDEX files each of which corresponds to the plurality of the MPEG files, too, are prepared.

When the designated MPEG file becomes full, the HDD 26 designates the succeeding MPEG and INDEX files as a recording destination. The MPEG-PS and the INDEX data that follow are recorded into the newly designated MPEG file and the INDEX file, respectively. An operation of thus updating the recording-destination file is defined as a “file stretching”.

It is noted that such the file stretching occurs at a time of the reproduction, too. That is, when the whole MPEG-PS is reproduced from the designated MPEG file, the succeeding MPEG file is designated as the reproduction destination, and the MPEG-PS is reproduced from the designated MPEG file.

If the operator makes a special setting, a plurality of the normal recording-use MPEG files are treated as a ring file. In this case, when all the normal recording-use MPEG files become full, an overwriting is executed in the order of oldest to most recent of the MPEG file. This enables to realize an eternal recording operation even though there is a limit to a time-period of the recorded video and the sound or voices.

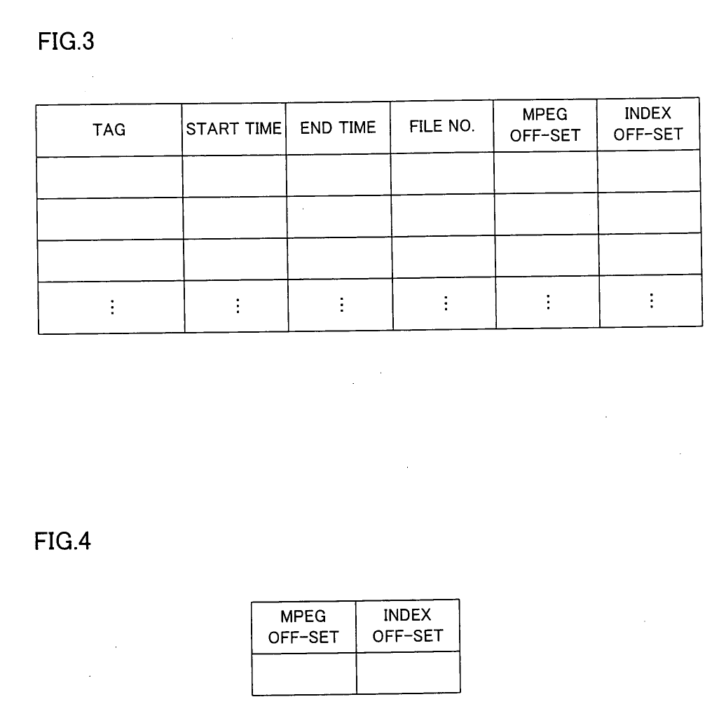

Furthermore, a managing file shown in FIG. 3 is also formed in the hard disk 28. Managing data stored in the managing file is segmented by each 24 bytes, and each 24 bytes represents six columns, that is, a tag (=4 bytes), a starting time (=4 bytes), an ending time (=4 bytes), a file number (=4 bytes), an MPEG off-set (=4 bytes), and an INDEX off-set (=4 bytes).

In the “tag” column, any one of identifiers, that is, an identifier REC_START indicating that the normal recording is started, an identifier REC_END indicating that the normal recording is suspended, an identifier MPEG_FILE_START indicating that a writing by the file stretching is started, an identifier MPEG_FILE_END indicating that the writing by the file stretching is ended, and an identifier INVALID indicating an invalid state, is written depending on a situation of the normal recording.

In the “start” column, a time at which a writing into the corresponding MPEG file is started is written. In the “end” column, a time at which the writing into the corresponding MPEG file is ended is written. In the “file number” column, the file number of the corresponding MPEG file is written. In the “MPEG off-set” column, a writing starting location of the corresponding MPEG file is recorded. In the “INDEX off-set” column, a location in which the INDEX data corresponding to a frame located in the MPEG off-set is written is written.

Furthermore, a recording information file shown in FIG. 4 is formed in the hard disk 28. In this recording information file, too, the columns of the “MPEG off-set” and the “index off-set” are formed. In the “MPEG off-set” column and the “Index off-set” column, a writing location of the MPEG-PS at a time of ending the normal recording, and a location in which the INDEX data corresponding to the frame of the writing location is written are written, respectively. By referring to such the recording information file, it is possible to specify the latest frame.

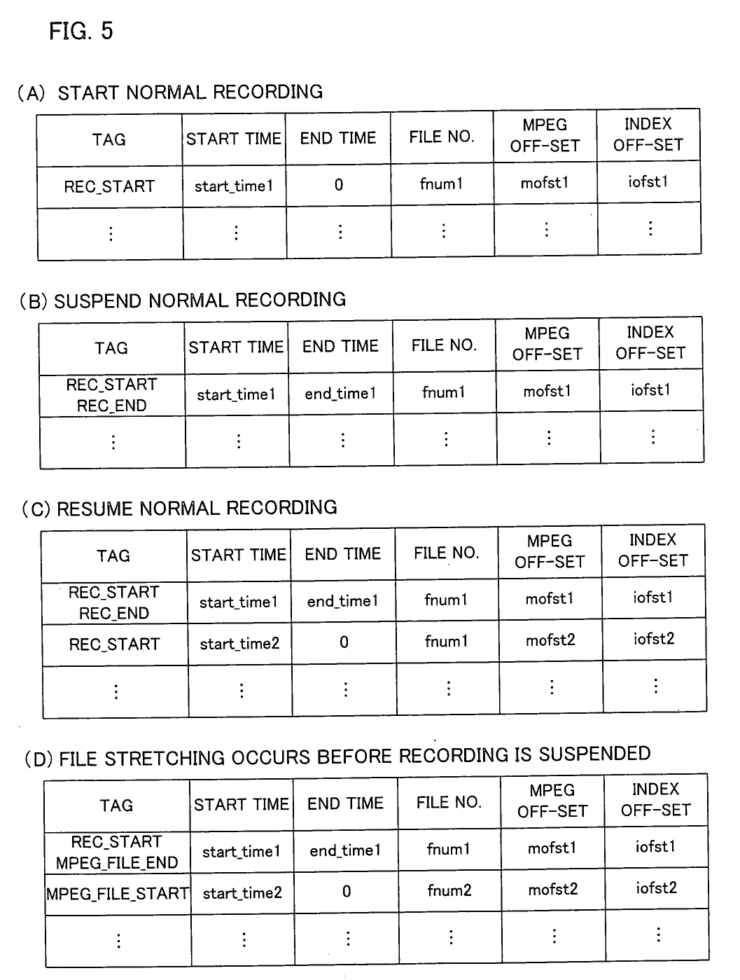

Referring to FIG. 5(A)-FIG. 5(D), the writing operation of the managing file will be described. Upon starting the normal recording, as shown in FIG. 5(A), the identifier REC_START is written into the “tag” column, and time information start_time1 indicating a starting time of the normal recording is written into the “starting time” column. In addition, a file number fnum1 indicating the MPEG file into which the MPEG-PS is written is written into the “file number” column. An MPEG off-set mofst1 indicating a writing starting location of the MPEG-PS, and an INDEX off-set iofst1 indicating a writing starting location of the INDEX data are written into the “MPEG off-set” column, and the “INDEX off-set” column, respectively. It is noted that the “ending time” column is remained as “0 (NULL)” at this time.

When the normal recording is suspended, as shown in FIG. 5(B), the identifier REC_END is additionally written into the “tag” column, and time information end_time1 indicating a suspended time of the normal recording is written into the “ending time” column.

When the normal recording is re-started, as shown in FIG. 5 (C), the succeeding 24 bytes of the managing data is noticed, and REC_START, start_time2, fnum1, mofst2, and iofst2 are written into the columns of “tag”, “starting time”, “file number”, “MPEG off-set”, and “INDEX off-set”.

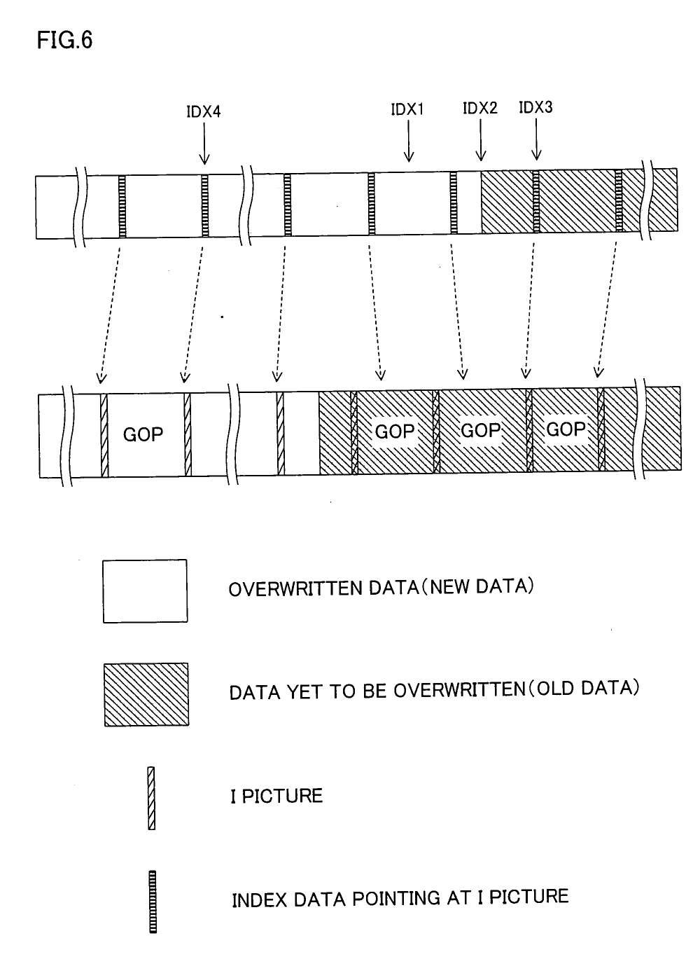

In addition, if the file stretching occurs in a writing state shown in FIG. 5(A), firstly, the identifier MPEG_FILE_END is additionally written into the “tag” column, and the time information end_time1 indicating a time at which the file stretching occurs is written into the “ending time” column as shown in FIG. 6(D). Next, 24 bytes of the succeeding managing data is noticed, and the identifier MPEG_FILE_START, time information start_time2 indicating a writing starting time into the succeeding MPEG file, a file number fnum2 indicating the succeeding MPEG file, the MPEG off-set mofst2 (=0), and the INDEX off-set iofst2 (=0), are written into the columns of “tag”, “starting time”, “file number”, “MPEG off-set”, and “INDEX off-set”.

As a result of such the managing file being created, it becomes possible to understand in what situation the last normal recording is ended. It is noted that the writing into the managing file is done only at a time of starting the recording, suspending the recording, and occurring the file stretching so that a charge to the CPU 50 and the HDD 26 is extremely small, thus not causing a problem to the recording operation.

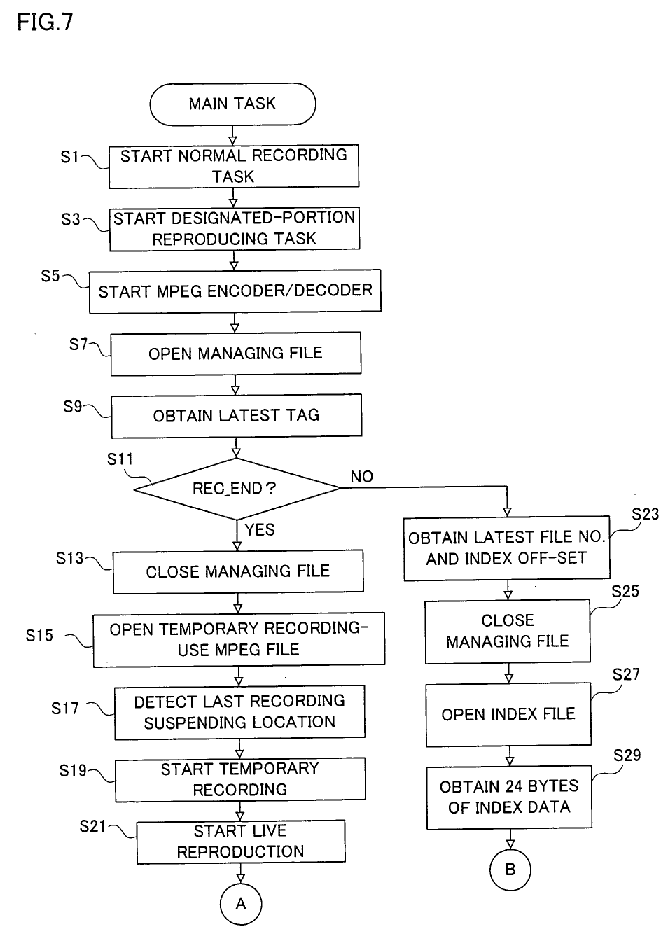

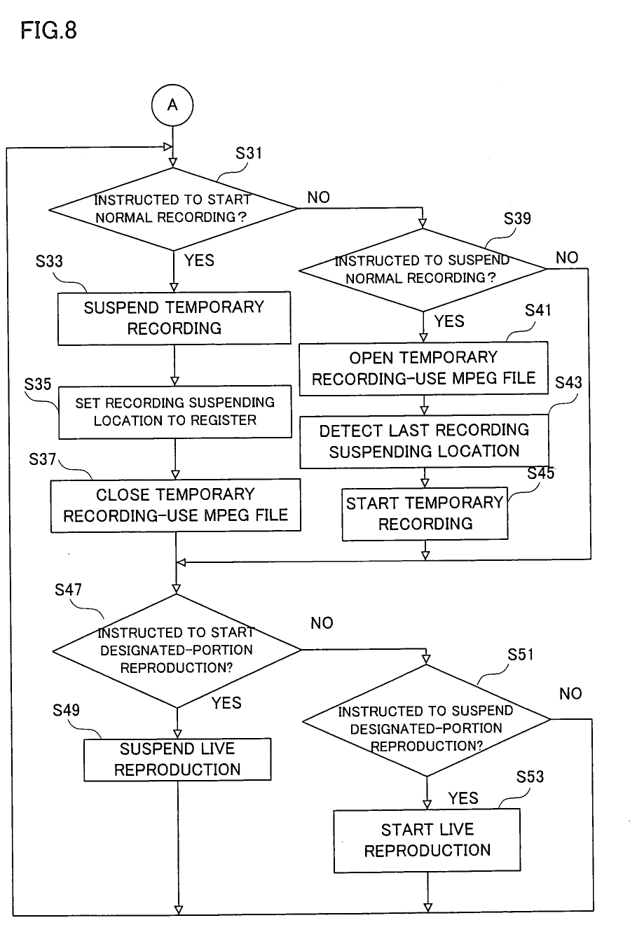

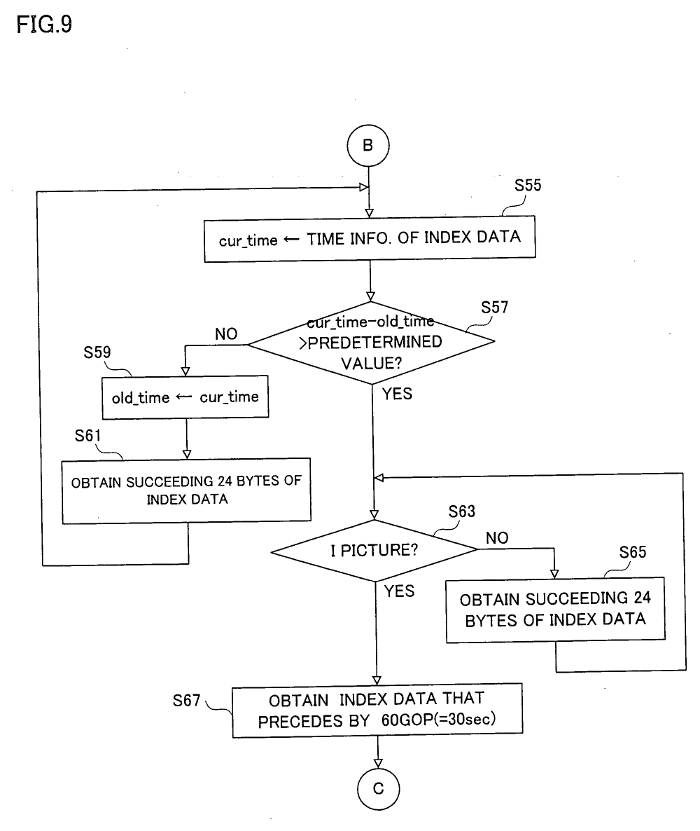

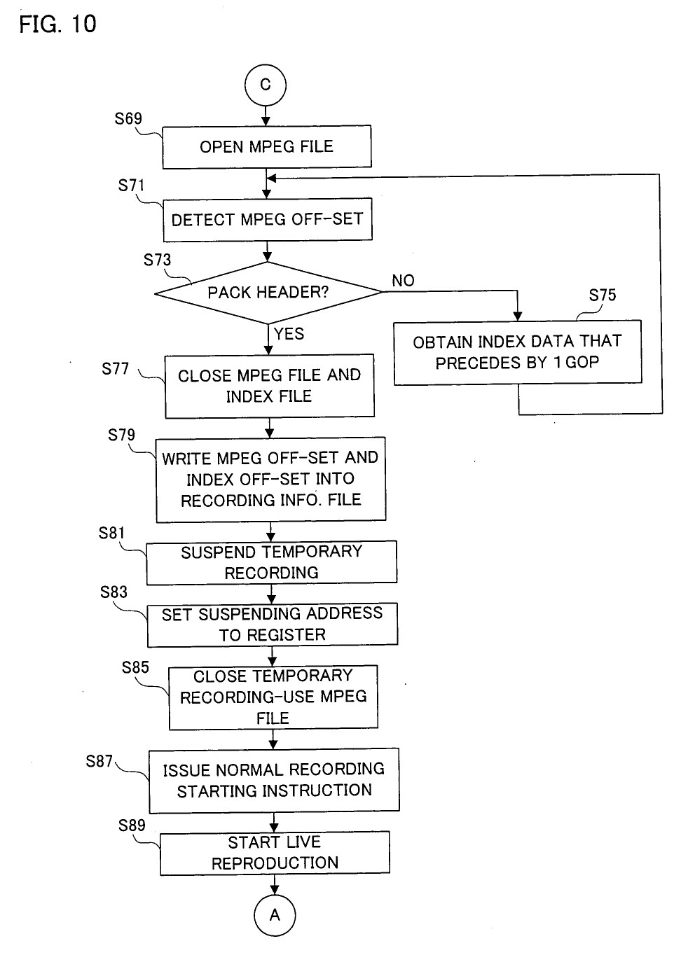

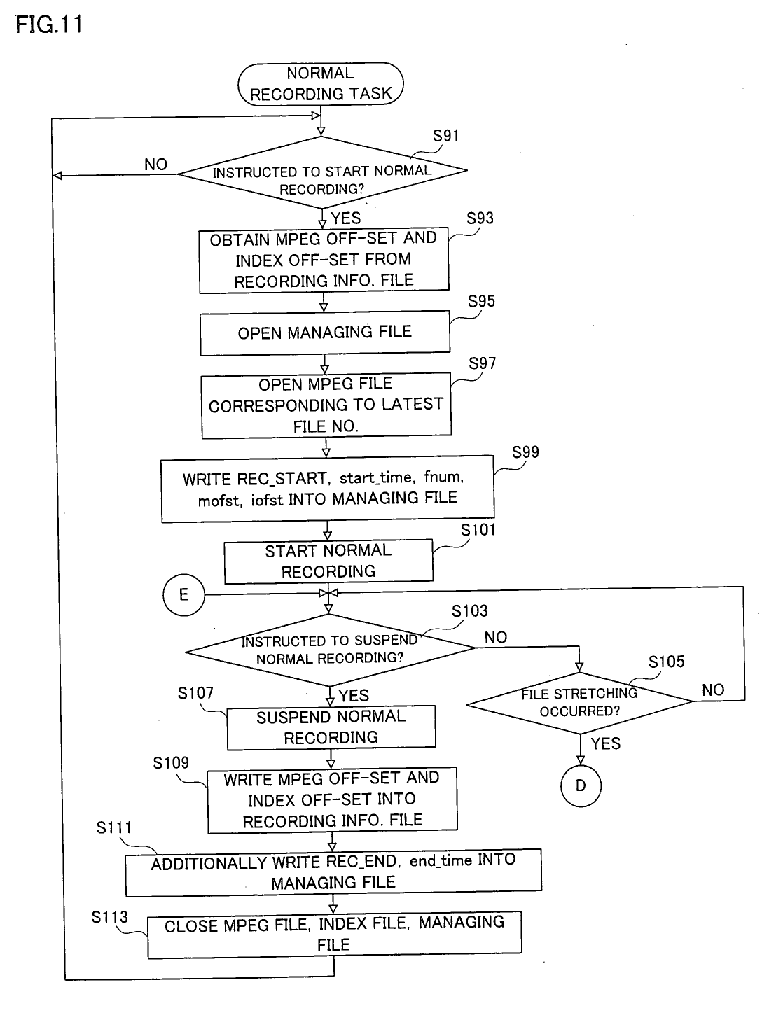

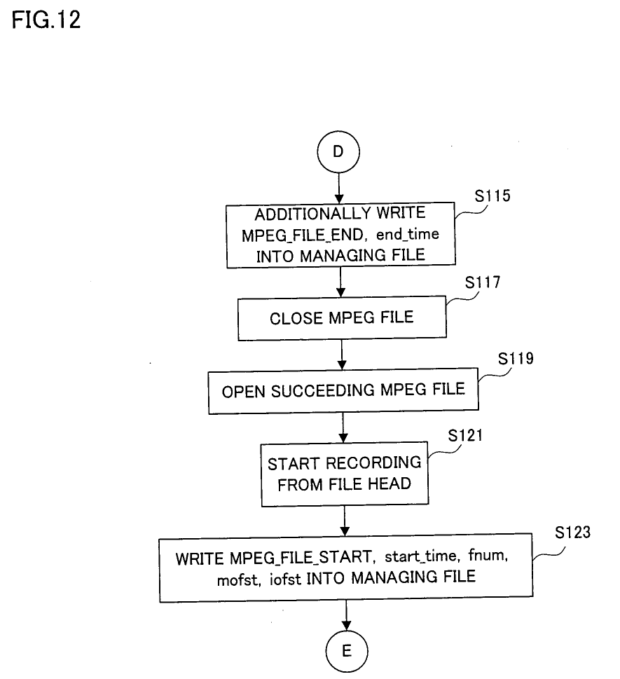

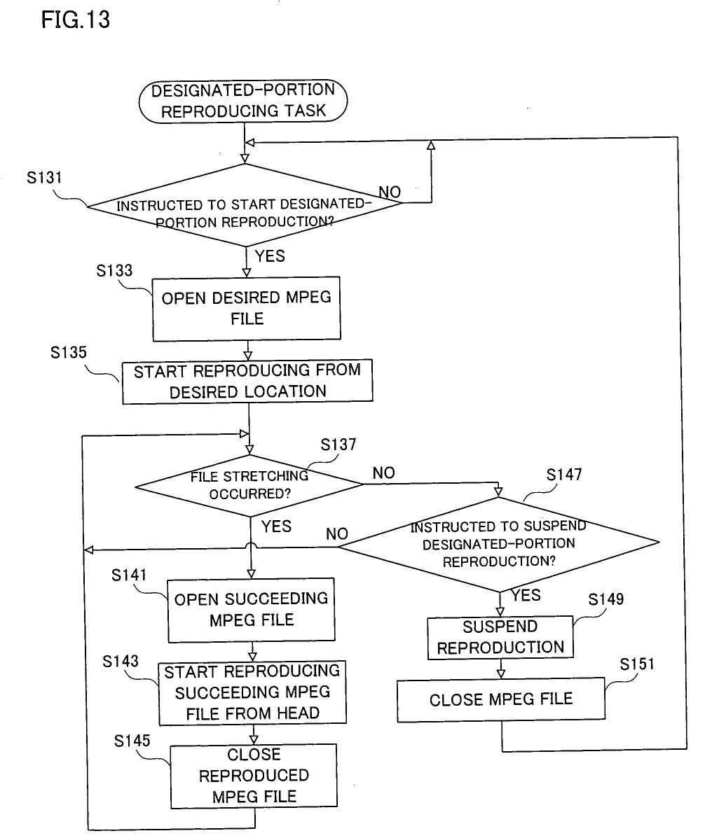

The CPU 50 is a multi-task CPU that executes a multi-task OS such as a μ ITRON, and executes a main task shown in FIG. 7-FIG. 10, a normal recording task shown in FIG. 11-FIG. 12, and a designated-portion reproducing task shown in FIG. 13 in a parallel manner. It is noted that a control program corresponding thereto is stored in a ROM 52.

Firstly, referring to FIG. 7, the normal recording task and the designated-portion reproducing task are started in steps S1 and S3, respectively, the MPEG encoder 44 and the MPEG decoder 46 are started in a step S5, and the HDD 26 is instructed to open the managing file in a step S7. In a step S9, the latest 24 bytes of the managing data included in the managing file is noticed, and the identifier written in the “tag” column of this managing data is obtained. In a step Sl1, the obtained identifier is determined.

In a case that the written identifier includes REC_END, the process advances to a step S13, determining that the last normal recording is normally ended. The HDD 26 is instructed to close the managing file in the step S13, the HDD 26 is instructed to open the temporary recording-use MPEG file in a step S15, and the recording suspending location set in a register not shown is detected in a step S17. The recording suspending location is the MPEG off-set and the INDEX off-set of the location in which the last temporary recording is suspended.

In a step S17, the HDD 26 is instructed to start the temporary recording from the detected recording suspending location, and the HDD 26 is instructed to start the live reproduction in a step S19. This allows the video and the sound or voices, to which the temporary recording is applied, to be output at the almost same time as the recording.

Upon starting the temporary recording and the live reproduction, it is determined whether or not a normal recording starting instruction is issued in a step S31, it is determined whether or not a normal recording suspending instruction is issued in a step S39, it is determined whether or not a designated-portion reproduction starting instruction is issued in a step S47, and it is determined whether or not a designated-portion reproduction suspending instruction is issued in a step S51.

When the normal recording starting operation is performed by an operation panel 54, the normal recording starting instruction is issued, when the normal recording suspending operation is performed by the operation panel 54, the normal recording suspending instruction is issued. In addition, when the designated-portion reproduction starting operation is performed by the operation panel 54, a designated-portion reproduction starting instruction is issued, and when the designated-portion reproduction suspending operation is performed by the operation panel 54, the designated-portion reproduction suspending instruction is issued.

If YES is determined in the step S31, the HDD 26 is instructed to suspend the temporary recording in a step S33, the MPEG off-set and the INDEX off-set indicating the recording suspending location is set to the register in a step S35, and the HDD 26 is instructed to close the temporary recording-use MPEG file in a step S37.

If YES is determined in the step S39, the HDD 26 is instructed to open the temporary recording-use MPEG file in a step S41, the last recording suspending location is detected from the register in a step S43, and the HDD 26 is instructed to start the temporary recording from this recording suspending location in a step S45.

If YES is determined in the step S47, the HDD 26 is instructed to suspend the live reproduction in a step S49. If YES is determined in the step S51, the HDD 26 is instructed to start the live reproduction in a step S53.

Returning to FIG. 7, unless the identifier written in the “tag” column of the managing data includes REC_END, the process advances from the step S11 to a step S23, assuming that the last normal recording is abnormally ended. In the step S23, the latest 24 bytes of the managing data is noticed, and the file number and the INDEX off-set are obtained from the columns of “file number” and “INDEX off-set” of this managing data, respectively. Upon completing an obtaining process, the HDD 26 is instructed to close the managing file in a step S25.

The HDD 26 is instructed to open the INDEX file corresponding to the obtained file number in a step S27, 24 bytes of the INDEX data that starts from the obtained INDEX off-set is obtained from the opened INDEX file in a step S29.

The time information included in the obtained INDEX data is set to a variable cur_time in a step S55, and it is determined whether or not a difference between the variable cur_time and a variable old_time exceeds a predetermined value in a step S57. NO is always determined in a first process of the step S57, and the variable cur_time is set to the variable old_time in a step S59. In a succeeding step S61, the succeeding 24 bytes of the INDEX data is obtained, and thereafter, the process returns to the step S55. Therefore, the INDEX data to be noticed is advanced by each 24 bytes until the difference of the time information included in 24 bytes of the INDEX data adjacent with each other exceeds the predetermined value.

If YES is determined in the step S57, the process advances to a step S63, and the frame type of the INDEX data to be noticed is determined. If the frame type is the P picture or the B picture, the succeeding 24 bytes of the INDEX data is obtained in a step S65, and the process returns to the step S63. Therefore, the INDEX data to be noticed is advanced until the I picture is detected.

If the I picture is detected, the process advances to a step S67 so as to obtain 24 bytes of the INDEX data from a location that precedes by 60 GOP (=30 seconds). In a step S69, the HDD 26 is instructed to open the MPEG file corresponding to the file number obtained in the step S23, and the MPEG off-set is deleted from the INDEX data to be noticed in a step S71.

It is noted that a reason why the INDEX data is obtained from the location that precedes by 60 GOP in the step S67 is that a processing speed of the MPEG encoder 44 and a capacity of the encoder buffer 24 are taken into consideration.

In a step S73, it is determined whether or not the pack header exists in the MPEG off-set location deleted in the step S55 regarding the opened MPEG file. Herein, if NO, the process advances to a step S75, assuming that imbalance occurs between the INDEX data and the MPEG-PS due to a deviance of a timing of the overwriting. In the step S75, 24 bytes of the INDEX data is obtained from the location that is preceded by 1 GOP, and then, the process returns to the step S71.

If the pack header exists in the location of the detected MPEG off-set, the process advances from the step S73 to a step S77, assuming that consistency is maintained between the INDEX data and the MPEG-PS. In a step S77, the HDD 26 is instructed to close the opened MPEG file and INDEX file, and in a step S79, the HDD 26 is instructed to write into the recording information file the detected latest MPEG off-set and the INDEX off-set indicating the location of the latest INDEX data. In the step S79, an opening/closing of the recording information file is also performed.

Next, in a step S81, the HDD 26 is instructed to suspend the temporary recording, the MPEG off-set and the INDEX off-set indicating the recording suspending location is set to the register in a step S83, and the HDD 26 is instructed to close the temporary recording-use MPEG file in a step S85. In a step S87, the normal recording starting instruction is issued, and in a step S89, the HDD 26 is instructed to start the live reproduction. Upon completion of the process in the step S89, the process advances to the step S31.

An operation when determined NO in the step S11 will be described by referring to FIG. 6. In a case that the INDEX data obtained in the step S29 is IDX1 shown in FIG. 6, NO is repeatedly determined in the step S57, and the INDEX data to be noticed is advanced by each 24 bytes by the process in the step S61. When the INDEX data to be noticed is advanced to IDX2 shown in FIG. 6, YES is determined in the step S57.

The video frame corresponding to IDX2 is not the I picture so that the INDEX data to be noticed is advanced once again by the process in the step S65. When the INDEX data to be noticed is advanced to IDX3 shown in FIG. 6, YES is determined in the step S63, the INDEX data to be noticed is returned over 60 GOP in the step S67. The INDEX data to be noticed becomes IDX4 shown in FIG. 6.

In the location specified by the MPEG off-set included in IDX4, the pack header exists. As a result, YES is determined in the step S73, the MPEG off-set included in IDX4 and the INDEX off-set indicating the location of IDX4 are written into the recording information file in the step S79. Thus, the head of GOP created before the recording operation is abnormally ended is specified.

It is noted that as understood from FIG. 6, if the INDEX data to be noticed is returned by 60 GOP, the MPEG off-set of the INDEX data to be noticed next usually points at the pack header. Therefore, the steps S73-S75 are preparatory processes.

The normal recording task is executed according to flowcharts shown in FIG. 11-FIG. 12. Firstly, it is determined whether or not the normal recording starting instruction is issued in a step S91, and if YES, the MPEG off-set and the INDEX off-set are obtained from the recording information file in a step S93. In the step S93, an opening/closing of the recording information file is also performed. In a step S95, the HDD 26 is instructed to open the managing file, and the HDD 26 is instructed to open the MPEG file corresponding to the latest file number in a step S97.

In a succeeding step S99, the HDD 26 is instructed to write into the managing file the identifier REC_START, the recording starting time start_time, the file number fnum, the MPEG off-set mofst, and the INDEX off-set iofst. Upon completion of the writing, the HDD 26 is instructed to start the normal recording in a step S101.

It is determined whether or not the normal recording suspending instruction is issued in a step S101, and it is determined whether or not the file stretching is occurred, that is, the writing-destination MPEG file becomes full, in a step S105. If YES in the step S103, the HDD 26 is instructed to suspend the normal recording in a step S107, and the HDD 26 is instructed to write into the recording information file the current MPEG off-set and INDEX off-set. In the step S109, an opening/closing of the recording ending information file is also performed.

In a step S111, the HDD 26 is instructed to additionally write into the managing file the identifier REC_END and the recording ending time end_time, and the HDD 26 is instructed to close the MPEG file, the INDEX file, and the managing file in a step S113. Then, the process returns to the step S81.

If YES in the step S105, the HDD 26 is instructed to additionally write into the managing file the identifier MPEG_FILE_END and the ending time end_time in a step S115, and the HDD 26 is instructed to close the MPEG file in a step S117. The HDD 26 is instructed to open the succeeding MPEG file in a step S119, and the HDD 26 is instructed to start recording from the head of the opened MPEG file. In a step S123, the HDD 26 is instructed to write into the managing file the identifier MPEG_FILE_START, the recording starting time start_time, the file number fnum, the MPEG off-set mofst, and the INDEX off-set iofst. Upon completion of the writing, the process returns to the step S103.

The designated-portion reproducing task is executed according to a flowchart shown in FIG. 13. Firstly, it is determined whether or not the designated-portion reproducing starting instruction is issued in a step S131, and if YES, the HDD 26 is instructed to open a desired MPEG file in a step S133. In a step S135, the HDD 26 is instructed to start reproducing from a desired location of the opened MPEG file. In a step S137, it is determined whether or not the file stretching is occurred, and it is determined whether or not the designated-portion reproduction suspending instruction is issued in a step S147.

If YES in the step S137, the succeeding MPEG file is opened in a step S141. In a step S143, the HDD 26 is instructed to start reproducing from the head of the opened MPEG file, and in a succeeding step S145, the HDD 26 is instructed to close the reproduced MPEG file. Upon completion of a closing process, the process returns to the step S137. If YES in the step S147, the HDD 26 is instructed to suspend the reproduction in a step S149, and the HDD 26 is instructed to close the MPEG file in a step S151. Then, the process returns to the step S121.

As understood from the above descriptions, a plurality of the MPEG files used for the normal recording have the same capacity (=1 G byte) to each other. The CPU 50 designates such the plurality of the MPEG files in the order from the MPEG file that serves as a reference (S97, S119). The MPEG-PS is written into the designated MPEG file by the HDD 26. In addition, the CPU 50 writes into the non-volatile managing file the file number that identifies the designated MPEG file at each time that the designation is updated (S123). Herein, the MPEG file that serves as the reference is the MPEG file specified by the latest file number stored in the managing file.

By writing the file number that identifies the designated MPEG file into the managing file at each time that the designation is updated, it becomes possible to easily identify into which MPEG file the writing operation is suspended during a time that the writing is being done. This enables to resume the recording operation from the vicinity of the recording ending location even when the abnormal ending of the normal recording is occurred.

In addition, the CPU 50 writes into the managing file the identifier REC_END (=marker) at a time of suspending the normal recording. Whether or not the identifier REC_END exists in the managing file is determined by the CPU 50 before the normal recording is started (S11). If this determination result is negative, the CPU 50 detects the temporal discontinuing point of the MPEG-PS from the MPEG file that serves as the reference (S57), and determines the writing starting location on the MPEG file based on the detected discontinuing point (S79). This enables to resume the recording operation from the recording suspending location within an error below 1 G byte.

It is noted that the hard disk video recorder of this embodiment is most effective used as a surveillance camera-use recorder that always photographs unattended.

It is noted that in this embodiment, a plurality of the MPEG files are previously formed in the hard disk. However, the MPEG file may be created at each time that the writing of the MPEG-PS is started. In addition, in this embodiment, all the normal recording-use MPEG files have the same capacity (=1 G byte), and however, the capacity may be different between the MPEG files.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A content recording apparatus, comprising:
a designator for designating in the order from a reference data file a plurality of data files;
a data writer for writing content data into the data file designated by said designator;
an information writer for writing into a non-volatile storing area file information that identifies the data file designated by said designator at each time that a designation of said designator is updated, wherein said reference data file is a data file specified by the latest file information stored in said non-volatile storing area.

2. A content recording apparatus according to claim 1, further comprising:
a marker writer for writing a marker into said non-volatile storing area at a time of ending a writing operation by said data writer;
a determiner for determining whether or not said marker exists in said non-volatile storing area before starting the writing operation by said data writer;
a detector for detecting a data discontinued point from said reference data file when a determination result of said determiner is negative; and
a determiner for determining a writing starting location on said reference data file based on the data discontinued point detected by said detector.

3. A content recording apparatus according to claim 2, wherein said content data includes moving image data having a plurality of frames of an image, and index data that manages each of said plurality of frames, and each of said plurality of data files includes a moving image file that stores said moving image data, and an index file that stores said index data.

4. A content recording apparatus according to claim 3, wherein said index data includes time information indicating a time at which each of said plurality of frames of an image has been obtained, and said detector detects said data discontinued point based on said time information.

5. A content recording apparatus according to claim 2, wherein said plurality of frames of an image include a first encoded image to which an intra-encoding is applied, and a second encoded image to which an inter-encoding is applied, and said determiner determines as said writing starting location a location that precedes said data discontinued point and in which said first encoded image exists.

6. A content recording apparatus according to claim 5, further comprising a buffer for temporarily holding said content data prior to the writing operation by said data writer, wherein said determiner determines said writing starting location taking into consideration a capacity of said buffer.

7. A content recording apparatus according to claim 1, wherein said plurality of data files have the same capacity to each other.

8. A content recording method, comprising the steps of:
(a) designating in the order from a reference data file each of a plurality of data files each of which has a predetermined capacity;
(b) writing content data into the data file designated by said step (a);
(c) writing into a non-volatile storing area file information that identifies the data file designated by said step (a) at each time that a designation of said step (a) is updated, wherein said reference data file is a data file specified by the latest file information stored in said non-volatile storing area.

9. A content recording method, comprising:
a recorder for recording into a recording medium content data formed of a plurality of partial contents;
a creator for creating index data including location information indicating a location of each of said plurality of partial contents, and time information indicating a time at which each of said plurality of partial contents has been obtained;
a detector for detecting a temporal discontinuing point of said index data based on said time information before a recording operation by said recorder is started; and
a first determiner for determining a location of starting recording said content data based on the temporal discontinuing point detected by said detector.

10. A content recording apparatus according to claim 9, further comprising:
a marker writer for writing a marker into a non-volatile storing area at a time of ending a recording operation by said recorder; and
a determiner for determining whether or not said marker exists in said non-volatile storing area when a power is input, wherein said detector detects said temporal discontinuing point when a determination result of said determiner is negative.

11. A content recording apparatus according to claim 10, further comprising:
an information writer for writing into said non-volatile storing area location information indicating an ending location of said recording operation; and
a second determiner for determining a location for starting recording said content data based on the location information written in said non-volatile storing area when the determination result of said determiner is affirmative.

12. A content recording apparatus according to claim 9, wherein said content data is moving image data having a plurality of frames of an image, each of said plurality of partial contents includes one of a first encoded image to which an intra-encoding is applied, and a second encoded image to which an inter-encoding is applied, and said first determiner determines as a recording starting location a head of the partial content including said first encoded image recorded in said recording medium.

13. A content recording apparatus according to claim 9, wherein a plurality of data files are formed in said recording medium, and said recorder sequentially records said content data into said plurality of data files.

14. A content recording method, comprising the steps of:
(a) recording into a recording medium content data formed of a plurality of partial contents;
(b) creating index data including location information indicating a location of each of said plurality of partial contents, and time information indicating a time at which each of said plurality of partial contents has been obtained;
(c) detecting a temporal discontinuing point of said index data based on said time information before a recording operation of said step (a) is started; and
(d) determining a location of starting recording said content data based on the temporal discontinuing point detected in said step (c).
